(19) United States
(12) Patent Application Publication
(10) Pub. No.: US 2004/0000635 A1
(43) Pub. Date: Jan. 1, 2004

(54) Arrangement for automatically adjusting for accumulated chromatic dispersion in a fiber optic transmission system

(76) Inventors: Stephan Wielandy, Hillsborough, NJ (US); Michael Fishteyn, Bridgewater, NJ (US)

Correspondence Address: Wendy W. Koba, PO Box 556, Springtown, PA, 18081, US

(21) Appl. No.: 10/184,155

(22) Filed: Jun. 27, 2002

(51) Int. Cl. G01J 4/00; G01J 5/08

(52) U.S. Cl. 250/227.18

(57) ABSTRACT

An automatically adjustable arrangement for tuning the accumulated chromatic dispersion present in an optical communication system uses a dispersion variation-based measuring arrangement to determine both the magnitude and sign of the accumulated dispersion. A relatively small portion of a received optical signal including an unknown amount of chromatic dispersion is tapped off at an optical receiver and a small amount of additional dispersion is added to the tapped-off signal so that nonlinear detection can be used to determine both the magnitude and sign of the dispersion present in the transmission signal. This information is then fed back to a tunable dispersion compensator to provide the real-time, automatic correction to the dispersion present in the system.

### FIELD OF THE INVENTION

The present invention relates to automatically controlling a tunable dispersion compensator (TDC) in a fiber optic transmission system and, more particularly, to using a differential measurement scheme to determine both the sign and magnitude of the accumulated dispersion for use in a closed-loop dispersion compensating system.

### BACKGROUND OF THE INVENTION

Fiber optic transmission systems are becoming increasingly popular for data transmission due to their high speed and high capacity capabilities. A common and well-known problem in the transmission of optical signals is chromatic dispersion of the optical signal. Chromatic dispersion refers to the effect where the different channels (bands) within a signal travel through an optical fiber at different speeds, i.e., shorter wavelengths travel faster than longer wavelengths. This problem becomes more acute for data transmission speeds greater than 2.5 Gb/s. The resulting pulses will be stretched, possibly overlapping, making it more difficult for a receiver to distinguish where one pulse ends and another begins. This seriously compromises the integrity of the signal and leads to an unacceptably high bit error rate. Therefore, for a fiber optic communication system to provide a high transmission capacity, the system must compensate for at least a portion of the chromatic dispersion present in the received signal.

A conventional solution to this problem is the use of fixed dispersion compensators at various locations in the network as needed. These devices compensate for a fixed dispersion value by canceling predetermined amounts of dispersion along the fiber link. The difficulty with used fixed dispersion compensators is that an optical link or network is rarely uniform. Different systems in the network may use different types of fiber, as well as different types of receivers with different tolerances. The fibers within a system may be of different lengths as necessitated by landscapes, building locations, etc. Also, different systems may contain devices from different vendors, each with its own dispersion tolerance. Thus, in order to obtain as close to optimum dispersion compensation through the entire system, the dispersion must be manually determined for every fiber and optical component in the system, and a dispersion compensator with the appropriate fixed value must be purchased and installed. This solution is costly to the network operator in both time and money.

The use of adjustable dispersion compensation addresses these disadvantages by allowing the dispersion compensation to be more easily optimized. Moreover, environment-induced factors may introduce real-time changes in the chromatic dispersion that cannot be accommodated by fixed dispersion compensation alone. At per-channel transmission rates of 40 Gb/s and higher, these changes are of sufficient magnitude to seriously impair system performance. Various adjustable tunable dispersion compensation methods currently exist, including the use of thermally- or strain-tuned fiber Bragg gratings with grating periods that may either be fixed or may vary with distance along the length of the grating, and the use of resonant cavities such as Fabry-Perot filters and ring-resonators. Although such devices can offer adjustable dispersion compensation, they must somehow be set to provide the appropriate amount of dispersion compensation. In particular, if the needed amount of compensation changes over time, tunable dispersion compensators must be combined with some real-time dispersion measurement method in order to maintain optical system performance.

### SUMMARY OF THE INVENTION

The need remaining in the prior art is addressed by the present invention, which relates to automatically controlling a tunable dispersion compensator (TDC) in a fiber optic transmission system and, more particularly, to using a differential measurement scheme to determine both the sign and magnitude of the accumulated dispersion for use in a closed-loop feedback system.

In accordance with the present invention, a portion of a received optical signal is tapped off and measured using nonlinear optical detection. A controlled amount of dispersion variation is imparted to the tapped off signal (such as, for example, dithering the amount of compensation applied by the TDC, forming a differential tapped-off signal, etc.). The dispersion variation present in the output from the nonlinear detection arrangement results in providing information for both the magnitude and sign of the chromatic dispersion present in the transmitted signal.

In a preferred embodiment, dispersion variation is created by passing the tapped-off signal through a pair of delay lines that introduce equal and opposite amounts of predetermined chromatic dispersion to the received signal. A pair of nonlinear detectors then captures the outputs from the delay lines and measures the accumulated dispersion in each signal. A difference signal is created from these outputs to form an error signal that can be fed back to a tunable dispersion compensator in the communication system. The use of a pair of delay lines with known and opposite values of dispersion allows for information regarding the sign of the dispersion, as well as its magnitude, to be collected.

In one arrangement, a pair of silicon-based avalanche photodiodes is used as the detector element, although any suitable type of photodetector may be used. The delay lines may utilize sections of dispersion compensating fiber to introduce the predetermined positive and negative chromatic dispersion, where known dispersions on the order of +25 ps/nm and −25 ps/nm have been found to be sufficient to allow for the measurement of dispersion magnitude and sign to be generated.

Other and further aspects and embodiments of the present invention will become apparent during the course of the following discussion and by reference to the accompanying drawings.

### BRIEF DESCRIPTION OF THE DRAWINGS

Referring now to the drawings,

FIG. 1 contains a curve illustrating the qualitative shape of the output of a nonlinear detector measuring accumulated chromatic dispersion;

FIG. 2 illustrates, in simplified form, a differential arrangement for measuring accumulated chromatic dispersion in accordance with the present invention;

FIG. 3 contains a graph illustrating the exemplary feedback signal transmitted to a tunable dispersion compensator so as to automatically compensate for the accumulated chromatic dispersion in a particular fiber optic transmission system;

FIG. 4 contains a diagram illustrating the dispersion measurements for a pair of detectors, as in the arrangement of FIG. 2, and the use of these measurements to determine the sign and magnitude of the accumulated chromatic dispersion; and

FIG. 5 contains a diagram of a specific embodiment of the present invention, including a feedback path from the differential measurement unit to a tunable dispersion compensation element.

### DETAILED DESCRIPTION

The measurement and mediation of chromatic dispersion is a critical issue in fiber optic communication systems. In particular, the ability to dynamically tune dispersion compensation is now recognized as a requirement for communication systems with per-channel data rates of 40 Gb/s and higher. For optimal system performance to be achieved and maintained, a feedback signal that is somehow sensitive to the net accumulated dispersion at the receiver is necessary to drive a tunable dispersion compensator (TDC) to the correct operating point. As will be discussed in detail below, the arrangement of the present invention provides such a dynamically available feedback signal by using a differential measurement scheme with a pair of nonlinear optical detector devices at the receiver.

A nonlinear detector produces an output signal S_{NL} that is proportional to the input optical power Pᵢₙ raised to the power of some nonlinear exponent γ. That is,

$${S}_{NL} ∝ {P}_{i n}^{γ}$$

When such a detector is exposed to a sequence of optical pulses with a fixed time-averaged input power, the nonlinear signal will depend on the temporal width τ of the pulses according to the relationship

S_{NL}∝τ^{1-γ}.

Furthermore, the optical pulsewidth generally increases in proportion to the magnitude of the accumulated chromatic dispersion. For the particular case of optical pulses that have a Gaussian temporal profile and a Fourier-transform-limited initial pulsewidth, the final pulsewidth τ_{f} depends on the accumulated dispersion D_{A} according to the following relationship:

$$\frac{{τ}_{f}}{{τ}_{i}} = \sqrt{1 + {( \frac{{λ}^{2}}{2 π c {τ}_{i}^{2}} {D}_{A} )}^{2}}$$

where λ is the optical wavelength and c is the speed of light. The nonlinear signal therefore depends on the accumulated dispersion according to the relationship:

$${S}_{NL} ∝ {( \sqrt{1 + {( \frac{{λ}^{2}}{2 π c {τ}_{i}^{2}} {D}_{A} )}^{2}} )}^{( 1 - γ )}$$

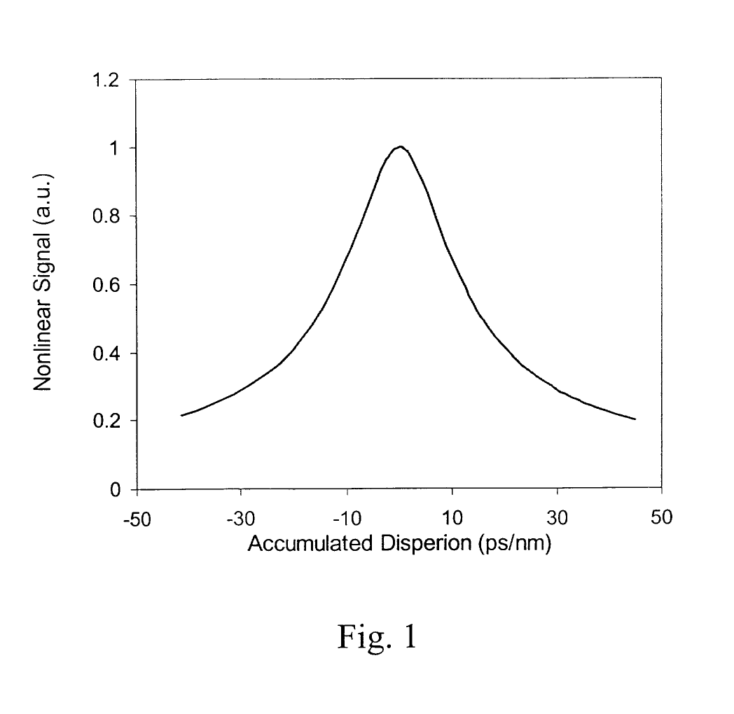

This relationship is illustrated in FIG. 1 for the particular case of pulses with a Gaussian profile and for γ=2, but the qualitative behavior is similar for other pulse shapes and nonlinear exponents. The relationship becomes more complicated if the pulses become so broad that consecutive pulses overlap significantly in time. The following are key features of relevance to the present invention: (1) zero accumulated dispersion is achieved when this signal is maximized; and (2) the symmetry of the nonlinear signal about the zero dispersion point means that a single nonlinear measurement can determine the magnitude, but not the sign, of the accumulated dispersion.

Two embodiments are proposed as a means of using nonlinear measurements as a feedback to a tunable dispersion compensator (TDC) in accordance with the present invention. As mentioned above, one method is to continuously vary the setting of the TDC (i.e., impart a “dither” to the value of the TDC) and monitor the tapped-off nonlinear signal. The optimum operating point will be found, in this embodiment, when small dispersion adjustments in either direction lead to a decrease in the nonlinear signal (as clearly seen by reference to FIG. 1). In a second embodiment, knowledge of the accumulated dispersion sign can be used to determine in which direction TDC tuning adjustments should be made to achieve optimal system performance without the need to continuously dither the TDC. A preferred method of providing the automatic adjustment in accordance with the present invention uses a pair of nonlinear detectors, which has been found to accurately determine both the magnitude and sign of the accumulated dispersion. In general, any method of providing dispersion variation can be used with a nonlinear detection arrangement to provide automatic control of TDC in accordance with the present invention.

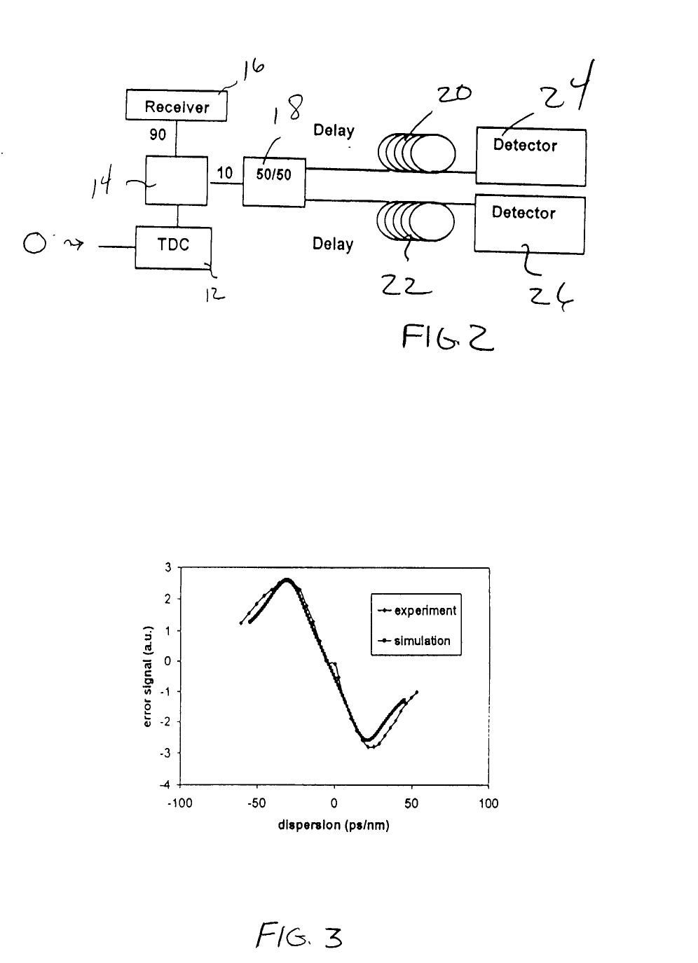

FIG. 2 illustrates an exemplary arrangement 10 that is used to measure the accumulated chromatic dispersion so as to provide information on both the magnitude and sign of the net dispersion. As shown, an optical signal O is propagating along a fiber optic transmission path and at some point in time will pass through a tunable dispersion compensator (TDC) 12. In accordance with the present invention, a predetermined portion of the optical signal is tapped off at the output TDC 12 by a splitter 14 located with an optical receiver 16. In general, a 90:10 splitter has been found to be acceptable, thus using only 10% of the received optical signal to determine the accumulated chromatic dispersion, where this minimal portion has been found to be sufficient to determine the accumulated dispersion without adversely affecting the quality of the received signal. The tapped-off signal is then passed through a 50:50 splitter 18 to provide for essentially equal power levels of the tapped-off signal to be coupled into a pair of delay paths 20 and 22 used to provide the differential measurements. In particular, delay paths 20 and 22 are configured to introduce equal and opposite chromatic dispersion into the optical signal passing therethrough. For example, delay path 20 is configured to introduce +D dispersion (ps/nm) into the optical signal and delay path 22 is configured to introduce −D dispersion (ps/nm) into the optical signal. A first nonlinear optical detector 24 is used to measure the accumulated chromatic dispersion at the output of first delay path 20 and a second nonlinear optical detector 26 is used to measure the accumulated chromatic dispersion at the output of second delay path 22. The difference signal obtained by subtracting the output of the two nonlinear detectors serves as the dispersion measurement.

FIG. 3 shows this difference curve plotted as a function of accumulated dispersion. The simulated data shown in FIG. 3 was calculated for the specific case of Gaussian pulses and for delay line dispersions of +25 ps/nm and −25 ps/nm; the qualitative behavior is known to be similar for other pulse shapes and other delay line dispersion values. For the accumulated dispersion between −25 ps/nm and +25 ps/nm, the difference signal uniquely determines the sign and magnitude of the accumulated dispersion. When used as a feedback signal to a TDC, the difference signal provides information about the appropriate direction to tune the TDC to achieve zero accumulated dispersion for any initial dispersion value.

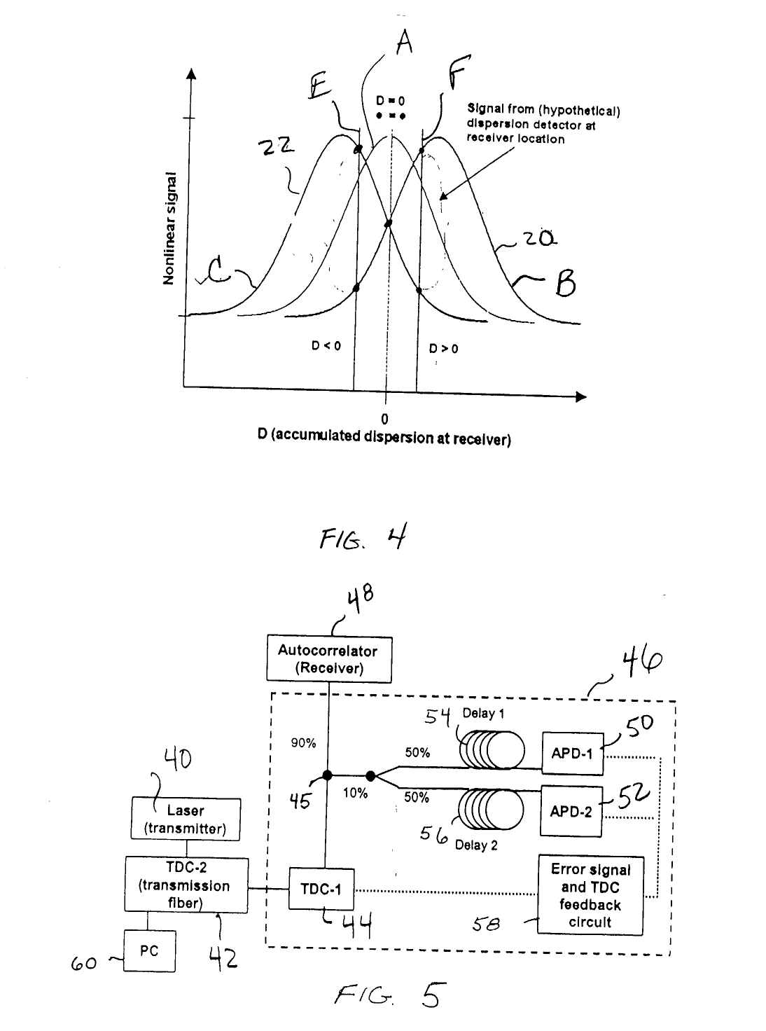

Referring in particular to FIG. 4, the operation of the differential arrangement of the present invention can be clearly understood. Curve A in FIG. 4, similar to the illustrated in FIG. 1, is associated with the hypothetical situation of utilizing a single detector to measure the accumulated chromatic dispersion at an optical receiver. As discussed above, the magnitude of the dispersion can be determined from this curve. However, the “sign” of the dispersion cannot be ascertained from this limited information. In accordance with the present invention, the use of delay lines 20 and 22 (FIG. 2) to introduce predetermined amounts of positive and negative dispersion into the received signal allows for the measurement of both the magnitude and sign of the accumulated dispersion to be achieved. Curve B in FIG. 4 is associated with the output signal from delay line 20, which exhibits a positive dispersion associated with the combination of the accumulated dispersion and the intentionally introduced positive dispersion, +D. Curve C in FIG. 4 is associated with the output signal from delay line 22, which exhibits a negative dispersion associated with the combination of the accumulated dispersion and the intentionally introduced negative dispersion, −D. The optimum situation will exist when tunable dispersion compensator 12 is operating at the point that yields zero net dispersion. Under this condition, curves B and C will intersect at the location of the maximum of curve A. As shown by reference to FIG. 4, when the measured accumulated dispersion is negative (i.e., the region where dispersion<0), the output signal measured by first detector 24 is less than the output signal measured by second detector 26. Line E in FIG. 4 illustrates one instance of this negative dispersion in particular. Similarly, when the measured accumulated dispersion is positive (i.e., the region where dispersion>0), the output signal measured by first detector 24 is greater than the output signal measured by second detector 26. Line F in FIG. 4 illustrates one particular instance of positive accumulated chromatic dispersion. In accordance with the present invention, therefore, the sign of the difference of these two signals provides the information necessary to determine the “sign” of the associated accumulated dispersion and, as a result, the direction that TDC 12 needs to be adjusted to correct for the presence of the dispersion. Thus, a difference circuit may be used to subtract the one output from the other, where the “sign” of the generated difference signal will correspond to the “sign” of the accumulated chromatic dispersion. The magnitude information for the adjustment can be derived from the size of the difference between curves B and C. Both the magnitude and sign information can then be fed back to TDC 12 to control the necessary adjustments to the dispersion compensation at that point.

In accordance with the present invention, detectors 24 and 26 can be any optical detection scheme that is sensitive to both the continuous wave (CW) input power and the total accumulated chromatic dispersion. As will be discussed in detail below, intensity-dependent detectors based on two-photon absorption in a semiconductor material may be a preferred arrangement. Alternatively, intensity-dependent detectors based on the combination of second harmonic generation in a χ₂ material, in association with a linear detector may be used, or a technique that includes monitoring of the broadened spectrum generated by self-phase modulation in a χ₃ material may be used.

FIG. 5 illustrates a particular embodiment of the present invention, illustrating the presence of a feedback loop between the detectors and the TDC, as well as the use of two-photon absorption detectors as the intensity-dependent nonlinear optical device. Two-photon absorption (TPA) occurs in a semiconductor detector with a band gap energy E_{g} when incident photons with an energy hv satisfy the condition that E_{g}/2<hv<E_{g}, and the result is an electrical output signal that depends quadratically on the intensity of the incident light. Such nonlinear optical detection based on TPA in various semiconductor detectors is now a widely-used means of characterizing laser pulses at wavelengths over the pertinent optical spectrum, as a result of its sensitivity, broad bandwidth and lack of sensitivity to the polarization state of the incident light. With a band gap of approximately 1.1 eV, silicon detectors exhibit TPA over a wavelength range of roughly 1.1 μm to 2.2 μm and are therefore well-suited for use as intensity-dependent detectors at wavelengths of interest for fiber optic communication. The inherent sensitivity of silicon avalanche photodiodes as linear detectors also makes them attractive as nonlinear detectors, and a silicon avalanche photodiode (Si-APD) has been shown to exhibit a quadratic response at peak optical input powers as low as 100 μW.

In the particular experimental arrangement as illustrated in FIG. 5, a mode-locked fiber laser 40 is tuned to 1552 nm, to produce pulses as short as 4 ps at a repetition rate of 10 GHz. The output from fiber laser 40 is then passed through a pair of cascaded fiber Bragg grating-based tunable dispersion compensators 42 and 44 that provide a total dispersion tuning range of approximately −400 ps/nm to +400 ps/nm, where the second TDC 44 is considered as an element of the automatically adjustable tunable dispersion compensation arrangement 46 of the present invention. As discussed above, the majority of the output signal from second TDC 44 is applied as an input to an optical receiver 48 (for example, 90% of the output signal), with a portion tapped off from an optical tap 45 (e.g., 10%) and used to differentially measure the accumulated chromatic dispersion and provide a corrective feedback signal to, in this case, second TDC 44. In this particular example, TDCs 42 and 44 are optimized for 40 Gb/s application (8.3 ps pulses) and slightly narrow the laser spectrum with the result that even for zero net dispersion (i.e., D=0) the minimum achievable pulse width at the output of TDC 44 is approximately 6 ps. A pair of silicon avalanche photodiodes 50 and 52 is used as the pair of quadratic detectors. By focusing the incident light onto these detectors to a spot size of approximately 5 μm, a nonlinear response for CW input powers between 5 μW and 200 μW is observed, which correspond to peak powers as low as 100 μW. The nonlinear exponent for this particular arrangement was observed to be 1.7 over this entire power range (i.e., signal ∝P^{1.7}), differing slightly from the expected quadratic (exponent 2) dependence associated with TPA, which may be due to the characteristics of the particular photon counting electronics in the APD module.

To demonstrate automatic accumulated dispersion compensation, arrangement 46 utilizes a pair of delay lines 54 and 56 that introduce dispersions of +25 ps/nm and −25 ps/nm, respectively, by including suitable lengths of dispersion compensating fiber (DCF) with a standard length (for example, 1.5 km) of conventional single mode fiber. Alternatively, a pair of fiber gratings can be used as delay lines 54 and 56, where the grating parameters (e.g., period, chirp, etc.) are configured to provide the desired additional amounts of positive and negative dispersion. Referring back to FIG. 5, the outputs from detectors 50 and 52 are then subtracted one from the other in a difference circuit 58 to form a difference signal indicative of the sign and magnitude of the accumulated dispersion. The difference signal, which can be thought of as an “error signal” for feedback control purposes, is fed back as the tuning adjustment signal to second TDC 44. To test the performance of the arrangement of the present invention, an external PC 60 was used to modify the dispersion introduced by first TDC 42 and measure the reaction of arrangement 46 to this change in accumulated dispersion. FIG. 3 illustrates both the predicted and measured error signals that were obtained using the arrangement as illustrated in FIG. 5.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the invention as defined by the appended claims.

What is claimed is:

1. An arrangement for automatically measuring and compensating for accumulated chromatic dispersion present in an optical signal propagating through a transmission system, the arrangement comprising:
a tunable dispersion compensation arrangement for receiving an optical input signal and imparting an adjustable amount of chromatic dispersion to the optical output signal as determined by an input control signal;
an optical signal tap disposed beyond the output of the tunable dispersion compensation arrangement for removing a tapped-off portion of the optical signal propagating through the transmission system;
a dispersion variation arrangement for introducing an amount of additional chromatic dispersion into the optical signal; and
a nonlinear optical detector arrangement for measuring the accumulated chromatic dispersion present in the tapped-off portion of the optical signal and generating a dispersion correction signal used as the input control signal to the tunable dispersion compensation arrangement.

2. The arrangement as defined in claim 1 wherein the dispersion variation arrangement includes a dithering element for constantly changing the dispersion introduced by the tunable dispersion compensation arrangement and the nonlinear optical detector arrangement functions to generate the dispersion correction signal by determining a maximum signal output based upon a condition when applied dither signal in either direction decreases the output signal.

3. The arrangement as defined in claim 1 wherein
the dispersion variation arrangement comprises
a splitter for dividing a portion of a received optical signal into essentially equal first and second optical signal components, each component exhibiting an amount of accumulated chromatic dispersion;
a first optical delay unit for introducing an amount of positive chromatic dispersion into the first optical signal; and
a second optical delay unit for introducing an amount of negative chromatic dispersion into the second optical signal, the amount of negative chromatic dispersion being equal in magnitude and opposite in sign to the amount of positive chromatic dispersion, and
the nonlinear optical detector arrangement comprises
a first nonlinear optical detector responsive to the output from the first optical delay unit;
a second nonlinear optical detector responsive to the output from the second optical delay unit; and
a subtracting arrangement coupled to the outputs from the first and second nonlinear optical detectors for generating a difference signal, defined as an error signal, indicative of the magnitude and sign of the accumulated chromatic dispersion present in the optical signal propagating through the transmission system.

4. The arrangement as defined in claim 3 wherein a tunable fiber Bragg grating is used as the tunable dispersion compensation arrangement.

5. The arrangement as defined in claim 3 wherein
the first optical delay unit comprises a section of single mode fiber of length L for introducing a positive chromatic dispersion +D ps/nm; and
the second optical delay unit comprises a section of dispersion compensating fiber for introducing a negative chromatic dispersion −D ps/nm.

6. The arrangement as defined in claim 3 wherein
the first optical delay unit comprises a first chirped fiber Bragg grating configured to introduce a positive chromatic dispersion +D ps/nm; and
the second optical delay unit comprises a second chirped fiber Bragg grating configured to introduce a negative chromatic dispersion −D ps/nm.

7. The arrangement as defined in claim 3 wherein the first and second nonlinear optical detectors comprise detectors with approximately quadratic intensity dependence.

8. The arrangement as defined in claim 7 wherein the quadratic detectors comprise silicon avalanche photodiodes.

9. An arrangement for automatically measuring accumulated chromatic dispersion in an optical transmission system, the arrangement comprising
a splitter for dividing a portion of a received optical signal into essentially equal first and second optical signal components, each component exhibiting an amount of accumulated chromatic dispersion;
a first optical delay unit for introducing an amount of positive chromatic dispersion into the first optical signal;
a second optical delay unit for introducing an amount of negative chromatic dispersion into the second optical signal, the amount of negative chromatic dispersion being equal in magnitude and opposite in sign to the amount of positive chromatic dispersion;
a first nonlinear optical detector responsive to the output from the first optical delay unit;
a second nonlinear optical detector responsive to the output from the second optical delay unit; and
a subtracting arrangement coupled to the outputs from the first and second nonlinear optical detectors for generating a difference signal, defined as an error signal, indicative of the magnitude and sign of the accumulated chromatic dispersion present in the optical signal propagating through the transmission system.

10. The arrangement as defined in claim 8 wherein
the first optical delay unit comprises a section of single mode fiber of length L for introducing a positive chromatic dispersion +D ps/nm; and
the second optical delay unit comprises a section dispersion compensating fiber for introducing a negative chromatic dispersion −D ps/nm.

11. The arrangement as defined in claim 8 wherein
the first optical delay unit comprises a first chirped fiber Bragg grating configured to introduce a positive chromatic dispersion +D ps/nm; and
the second optical delay unit comprises a second chirped fiber Bragg grating configured to introduce a negative chromatic dispersion −D ps/nm.

12. The arrangement as defined in claim 9 wherein the first and second nonlinear optical detectors comprise detectors with approximately quadratic intensity dependence.

13. The arrangement as defined in claim 12 wherein the quadratic detectors comprise silicon avalanche photodiodes.
